(19) United States
(12) Patent Application Publication
(10) Pub. No.: US 2009/0002639 A1
(43) Pub. Date: Jan. 1, 2009

(54) Fly-Eye Lens, Optical Unit and Display Apparatus

(76) Inventors: Roger Corn, Tokyo (JP); Daisuke Okamoto, Tokyo (JP)

Correspondence Address: David W. Hill;FINNEGAN, HENDERSON, FARABOW,, GARRETT & DUNNER, L.L.P., 901 New York Avenue, N.W., Washington, DC, 20001-4413, US

(21) Appl. No.: 12/145,059

(22) Filed: Jun. 24, 2008

(30) Foreign Application Priority Data
Jun. 28, 2007 (JP) 2007-170148

(51) Int. Cl. G03B 21/00; G02B 27/10

(52) U.S. Cl. 353/31; 359/628

(57) ABSTRACT

A fly-eye lens includes multiple sub-lenses laid out in a matrix form, wherein a part of the lens surface of one sub-lens of the multiple sub-lenses has an oddly-shaped part having a different shape from the shape of the lens surface of the other sub-lenses.

### CROSS REFERENCES TO RELATED APPLICATIONS

The present invention contains subject matter related to Japanese Patent Application JP 2007-170148 filed in the Japanese Patent Office on Jun. 28, 2007, the entire contents of which being incorporated herein by reference.

### BACKGROUND OF THE INVENTION

1. Field of the Invention

The present invention relates to a fly-eye lens including multiple sub-lenses laid out in a matrix form and an optical unit and display apparatus including the fly-eye lens.

2. Description of the Related Art

A projection display apparatus such as a liquid crystal projector divides the light emitted from a light source into three primary color rays of R (red), G (green) and B (blue), guides them to respectively corresponding optical modulators (such as liquid crystal panels) through respective predetermined paths, modulates them and synthesizes them at a synthesis prism, the result of which is then enlarged and projected on a screen through a projection optical system (refer to JP-A-10-133303 (Patent Document 1), for example).

In this case, a fly-eye lens is provided in a subsequent stage of a light source in order to collect light emitted from the light source to an optical modulator efficiently and evenly. A fly-eye lens includes multiple sub-lenses in a matrix form and allows superimposition and irradiation of light collected by the sub-lenses.

### SUMMARY OF THE INVENTION

However, it is significantly difficult to align the center of the illumination area resulting from the light collection by the fly-eye lens and the center of the display area of a liquid crystal panel, which is an optical modulator. In other words, it is significantly difficult to determine whether the center of the illumination area and the center of the display area of a liquid crystal panel agree or not since an image is generally displayed without any missing part if the display area of the liquid crystal panel is within the illumination area. For that reason, it is important to replace them based on whether the mechanical alignment of the fly-eye lens and the liquid crystal panel is w thin the permissible range or not. In this case, the agreement of the centers is not actually determined, and the misalignment if any may deteriorate the evenness of the displayed image.

According to an embodiment of the present invention, there is provided a fly-eye lens including multiple sub-lenses laid out in a matrix form, wherein a part of the lens surface of one sub-lens of the multiple sub-lenses has an oddly-shaped part having a different shape from the shape of the lens surface of the other sub-lenses.

According to the embodiment of the invention, since a part of the lens surface of one sub-lens of the multiple sub-lenses configuring the fly-eye lens has an oddly-shaped part, a different image is formed by the oddly-shaped part from those of the other sub-lenses, and it can be used as a mark for the alignment.

The oddly-shaped part may be provided at one of the multiple sub-lenses or a sub-lens at the outermost part of the multiple sub-lenses. The shape of the oddly-shaped part may have a portion concave or convex against the lens surface.

In a case where any one or one at the outermost part of the multiple sub-lenses has an oddly-shaped part, the oddly-shaped part is projected as a result of the image forming by using the sub-lens. The projected oddly-shaped part can be used as a mark for the alignment of the fly-eye lens. Since the light beams collected by the sub-lenses are integrated in a case where an image is formed by using all of the sub-lenses, the effect of the image forming by the oddly-shaped part is at an unrecognizable level.

According to another embodiments of the invention, there are provided an optical unit and a display apparatus including the fly-eye lens. Thus, the fly-eye lens can be aligned by using the image formed by the oddly-shaped part, and the illumination area by the fly-eye lens and the display area by an optical modulator can be aligned accurately.

The embodiments of the invention may provide following advantages. That is, the illumination area by the fly-eye lens can be aligned with the illumination subject accurately. Therefore, the optical unit and display apparatus including the fly-eye lens allow accurate alignment of the center of the illumination area by the fly-eye lens and the center of the display area by an optical modulator and can provide a highly even image.

### BRIEF DESCRIPTION OF THE DRAWINGS

FIGS. 1A to 1D are schematic diagrams illustrating a fly-eye lens according to an embodiment of the invention;

FIG. 2 is a schematic diagram showing an example of the display apparatus (or liquid crystal projector) including the fly-eye lens of the embodiment of the invention;

FIG. 3 is a schematic diagram illustrating the configuration of the display apparatus (or rear-projector) applying the fly-eye lens 10 according to the embodiment;

FIG. 4 is a schematic diagram illustrating a light-shield member for alignment; and

FIGS. 5A and 5B are schematic diagrams illustrating a routine of an alignment method.

### DESCRIPTION OF THE PREFERRED EMBODIMENTS

With reference to drawings, embodiments of the invention will be described below.

### [Fly-Eye Lens]

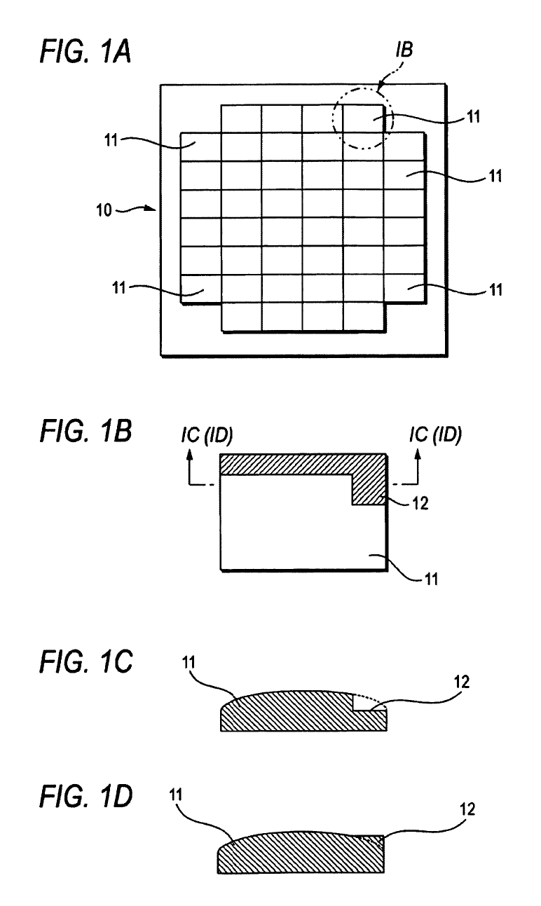

FIGS. 1A to 1D are schematic diagrams illustrating a fly-eye lens according to an embodiment of the invention. FIG. 1A is a plan view, FIG. 1B is an enlarged view of the part A in FIG. 1A, FIG. 1C is a section view (#1) taken on the line a-a in the Part-A enlarged view in FIG. 1B, and FIG. 1D is a section view (#2) taken on the line a-a in the Part-A enlarged view in FIG. 1B.

As shown in FIG. 1A, a fly-eye lens 10 according to the embodiment of the invention includes multiple sub-lenses 11 laid out in a matrix form and is an optical integrator that superimposes light beams converged by the sub-lenses 11 to one position.

The fly-eye lens 10 according to this embodiment is characterized in that a part of the lens surface of any one sub-lens 11 of the multiple sub-lenses 11 has an oddly-shaped part 12 having a different shape from the shape of the lens surfaces of the other sub-lenses 11.

In the example shown in FIG. 1A, one sub-lens 11 at the outermost part shown at Part A, of the multiple sub-lenses 11 has the oddly-shaped part 12. As shown in FIG. 1B, the sub-lens 11 shown at Part A in FIG. 1A has the shaded oddly-shaped part 12 at a part of the lens surface. The oddly-shaped part 12 has an L-shape at the plan view.

The section shape of the oddly-shaped part 12 may be a concave portion shown in FIG. 1C or a convex portion shown in FIG. 1D. The concave portion shown in FIG. 1C has a notch at a part of the lens surface of the sub-lens 11 and may have a flat surface, for example, so as to prevent light collection.

The concave portion shown in FIG. 1D has a projection from an expected lens surface at a part of the lens surface of the sub-lens 11 and may have a flat surface, for example, so as to prevent light collection.

In both examples, a part of the lens surface has the oddly-shaped part 12 having a form that does not function as a lens. The shape of the oddly-shaped part 12 is not limited to those described above. In order to prevent the function as a lens, a part of the lens surface may have an area that does not transmit light and may be used as the oddly-shaped part 12.

By providing the oddly-shaped part 12 at any one sub-lens 11 of the fly-eye lens 10, the sub-lens 11 forms a different image from those by the other sub-lenses 11, and the different image can be used as a mark for the alignment.

### [Display Apparatus: Liquid Crystal Projector]

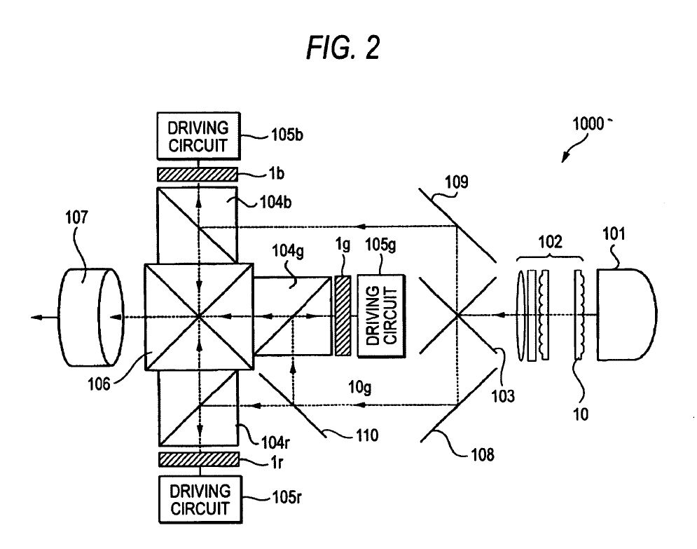

FIG. 2 is a schematic diagram showing an example of the display apparatus (or liquid crystal projector) including the fly-eye lens of this embodiment. That is, the liquid crystal projector 1000 includes a light source 101, a lens unit 102, a dichroic color separation filter 103, beam splitters 104r, 104g and 104b, liquid crystal display devices 1r, 1g and 1b, driving circuits 105r, 105g and 105b, a prism (dichroic mirror) 106 and a projection lens 107.

In the liquid crystal projector 1000, the fly-eye lens 10 of this embodiment as described above is applied to one of two fly eye lenses in the lens unit 102.

In this system, the light emitted from the light source 101 is transmitted from the lens unit 102 to the dichroic color separation filter 103, where the light is split into two directions. The light beams split into two directions are transmitted to the display unit including the reflective liquid crystal display devices 1r, 1g and 1b corresponding to the three colors of R (red), G (green) and B (blue) through all-reflection mirrors 108 and 109, the beam splitters 104r, 104g and 104b, the dichroic mirror 110 and the prism 106.

For example, the light from the light source 101 enters to the liquid crystal display device 1r corresponding to R (red) from the dichroic color separation filter 103 through the all-reflection mirror 108 and the beam splitter 104r. The light from the light source 101 enters to the liquid crystal display device 1g corresponding to G (green) from the dichroic color separation filter 103 through the all-reflection mirror 108, the dichroic mirror 110 and the beam splitter 104g. The light from the light source 101 enters to the liquid crystal display device 1b corresponding to B (blue) from the dichroic color separation filter 103 through the all-reflection mirror 109 and the beam splitter 104b.

The liquid crystal display devices 1r, 1g and 1b are provided through the beam splitters 104r, 104g and 104b respectively for multiple planes of the prism 106, which is a dichroic mirror. The liquid crystal display devices 1r, 1g and 1b are driven by the corresponding driving circuits 105r, 105g and 105b, respectively, and reflect the incident light as images by the liquid crystal layers. The images are synthesized by the prism 106, and the result is transmitted to the projection lens 107. Thus, the images corresponding to the three colors of R (red), G (green) and B (blue) are projected on a screen, not shown, and are reproduced as a color image.

The liquid crystal projector shown in FIG. 2 is a reflection liquid crystal projector that reflects and modulates the light emitted from the light source 101 at the liquid crystal display devices 1r, 1g and 1b but is also applicable to a transmission liquid crystal projector that transmits and modulates light by the liquid crystal display devices 1r, 1g and 1b.

### [Optical Unit]

The fly-eye lens 10 according to this embodiment in combination with an optical part is applicable as an optical unit. In other words, the optical unit is a combination of the fly-eye lens 10 according to this embodiment and an optical part and may include a combination of the lens unit 102 containing the fly-eye lens 10 according to this embodiment, the dichroic color separation filter 103, the all-reflection mirrors 108 and 109, the dichroic mirror 110, the display devices (or the liquid crystal display devices 1r, 1g and 1b) and the beam splitters 104r, 104g and 104b respectively corresponding to the display devices in the configuration of the liquid crystal projector 1000 shown in FIG. 2. However, other combinations are also configurable as the optical module.

### [Display Apparatus: Rear-Projector]

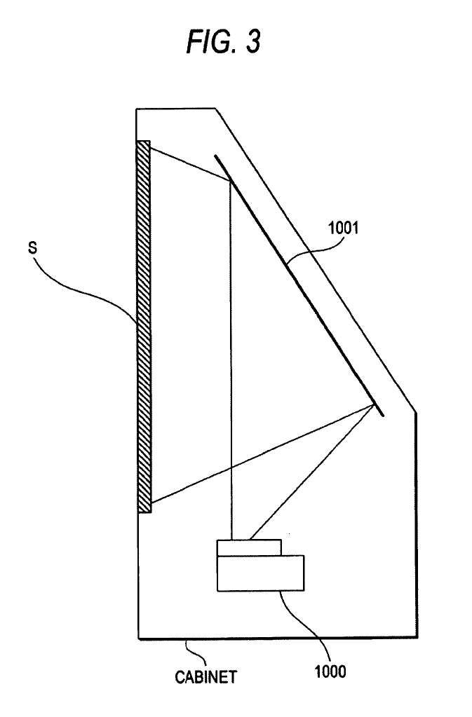

FIG. 3 is a schematic diagram illustrating the configuration of a display apparatus (rear-projector), to which the fly-eye lens 10 according to an embodiment of the invention is applied. The rear-projector includes a liquid crystal projector 1000 within a cabinet, a back mirror 1001 and a screen S.

The liquid crystal projector 1000 has the configuration shown in FIG. 2 as described above and synthesizes the images resulting from the modulation by the liquid crystal display devices 1r, 1g and 1b and outputs the synthesized image from the projection lens 107 to the back mirror 1001. The synthesized image output from the liquid crystal projector 1000 is enlarged and is reflected by the back mirror 1001 and is irradiated to the back of the screen S. The synthesized image irradiated to the screen S can be referred from the outside of the cabinet.

### [Alignment Method]

The fly-eye lens 10 of this embodiment, which is applicable to the display apparatus and optical unit as described above allows the alignment of the irradiation area of a light source and the display area of a liquid crystal display apparatus by using the oddly-shaped part 12 of the sub-lens 11 as described above.

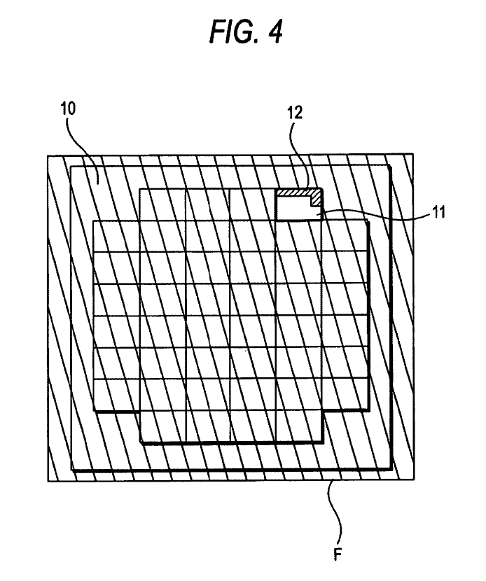

For the alignment, as shown in FIG. 4, the part excluding the sub-lens 11 having the oddly-shaped part 12 of the fly-eye lens 10 is first covered with the light-shield member F. Thus, the light emitted from a light source is only irradiated to the sub-lens 11 having the oddly-shaped part 12 and is not irradiated to the other sub-lenses 11.

Next, the light emitted from the light source is collected only by using the sub-lens 11 having the oddly-shaped part 12, and the image is projected on the screen S through a general optical unit. The signal of the image modulated by a liquid crystal display apparatus gives the entire display area with even lightness. Thus, the projected image shown on the screen S has even lightness by irradiating light evenly to the display area of the liquid crystal display apparatus.

However, according to this embodiment, if the light collected only by using the sub-lens 11 having the oddly-shaped part 12 is irradiated to a liquid crystal display apparatus, the projected image of the part corresponding to the oddly-shaped part 12 is shown darker than other parts since the light is not collected by the part having the oddly-shaped part 12. Therefore, the projected image of the part corresponding to the oddly-shaped part 12 can be the reference for the alignment.

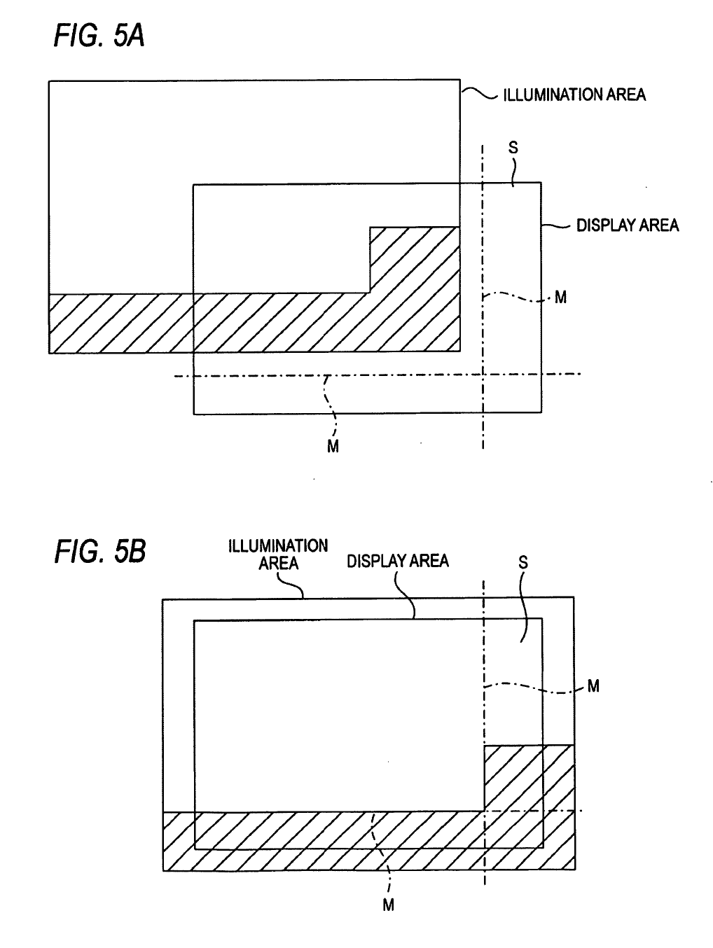

FIGS. 5A and 5B are schematic diagrams illustrating a procedure of the alignment method using a projected image of an oddly-shaped part. First of all, the optical unit is assembled. Then, by only using the sub-lens 11 having the oddly-shaped part 12 before the alignment, the light from a light source is irradiated, and the image is projected.

FIG. 5A is a schematic diagram showing a projected image on the screen before the alignment. Since it is before the alignment, the illumination area through the fly-eye lens is different from the display area by the liquid crystal display apparatus (or display area on the screen). In this case, the illumination area also shows the projected image (shaded in the figure) of the part corresponding to the oddly-shaped part 12 (refer to FIG. 1B) in the sub-lens 11.

A mark M, which has been correlated with the display area by the liquid crystal display apparatus in advance, is provided on the screen S. The mark M may be a cross-hair including the vertical and horizontal lines, for example, and the difference between the vertical and horizontal mark M and the vertical and horizontal outer lines of the projected image of the part corresponding to the oddly shaped part 12 in the illumination area indicates a displacement of the illumination area. In other words, by aligning the vertical and horizontal outer lines of the projected image of the part corresponding to the oddly-shaped part 12 in the illumination area with the vertical and horizontal mark M on the screen S, the center of the illumination area agrees with -he center of the display area.

In order to adjust the position of the illumination area, the positions of the lenses and mirrors on the optical path may be adjusted. The adjustment moves the illumination area and is performed until the vertical and horizontal outer lines of the projected image of the part corresponding to the oddly-shaped part 12 in the illumination area agrees with the position of the vertical and horizontal mark M on the screen S. Then, as shown in FIG. 5B, when the vertical and horizontal outer lines of the projected image of the part corresponding to the oddly-shaped part 12 in the illumination area agrees with the position of the vertical and horizontal mark M on the screen S, the center of the illumination area agrees with the center of the display area, and thereby the upper, lower, left and right margins of the illumination area and the display area are equal.

After the completion of the alignment, the light-shield member F covering the fly-eye lens 10 shown in FIG. 4 is removed. Thus, light collection by using all of the sub-lenses 11 can be implemented. In this case, the sub-lens 11 having the oddly-shaped part 12 may be used as it is since the images of the light collected by the other sub-lenses 11 without the oddly-shaped part 12 are placed one over another and is made even at the unrecognizable level by the unaided eyes in real usages.

In this way, since light collection is performed by using the sub-lens 11 having the oddly-shaped part 12, the sub-lens 11 having the oddly-shaped part 12 is desirably provided at one of the corners of the sub-lenses at the outermost part of the fly-eye lens 10. Since the light irradiated from the light source can be the weakest at that part, the influence of the image of the oddly-shaped 12 on the superimposed light can be reduced most.

### [Advantages]

The alignment as described above can adjust the position of the illumination area easily and accurately by using the fly-eye lens 10 actually built in a display apparatus, without the adjustment of the position of the illumination area by using special adjustment jig. Since the adjustment can be performed with the fly-eye lens 10 built in an actual display apparatus, the error due to the re-installation, which may occur in the adjustment using a special adjustment jig, can be prevented, and the error among parts can be absorbed, which allows stable adjustment.

Having described the examples in which the fly-eye lens 10 is used mainly in a display apparatus such as a liquid crystal projector according to the embodiments above, the fly-eye lens 10 in other optical apparatus is also applicable to the alignment and/or center alignment between the superimposed image by the fly-eye lens 10 and a subsequent target area.

It should be understood by those skilled in the art that various modifications, combinations, sub-combinations and alterations may occur depending on design requirements and other factors insofar as they are within the scope of the appended claims or the equivalents thereof.

What is claimed is:

1. A fly-eye lens comprising:
multiple sub-lenses laid out in a matrix form,
wherein a part of the lens surface of one sub-lens of the multiple sub-lenses has an oddly-shaped part having a different shape from the shape of the lens surface of the other sub-lenses.

2. The fly-eye lens according to claim 1, wherein the sub-lens having the oddly-shaped part is one of the multiple sub-lenses.

3. The fly-eye lens according to claim 1, wherein the sub-lens having the oddly-shaped part is a sub-lens laid out at the outermost part of the multiple sub-lenses.

4. The fly-eye lens according to claim 1, wherein the oddly-shaped part has a portion concave against the lens surface.

5. The fly-eye lens according to claim 1, wherein the oddly-shaped part has a portion convex against the lens surface.

6. An optical unit that collects the light irradiated from a light source through a fly-eye lens, divides the light to multiple color rays and guides them to optical modulators for respective colors,
wherein the fly-eye lens of the optical unit includes:
multiple sub-lenses laid out in a matrix form; and
a part of the lens surface of one sub-lens of the multiple sub-lenses has an oddly-shaped part having a different shape from the shape of the lens surface of the other sub-lenses.

7. A display apparatus comprising:
a light source;
an optical unit that divides the light irradiated from the light source into multiple color rays, guides them to optical modulators for respective colors and synthesizes the rays modulated by the optical modulators; and
a projection optical system that projects the light synthesized by the optical unit,
wherein the fly-eye lens of the optical unit includes
multiple sub-lenses laid out in a matrix form; and
a part of the lens surface of one sub-lens of the multiple sub-lenses has an oddly-shaped part having a different shape from the shape of the lens surface of the other sub-lenses.
